(19) United States
(12) Patent Application Publication
(10) Pub. No.: US 2025/0211613 A1
(43) Pub. Date: Jun. 26, 2025

(54) IMPERSONATION ATTACK DETECTION AND PREVENTION SYSTEM

(71) Applicant: Kyndryl, Inc., New York, NY (US)

(72) Inventors: Cesar Augusto Rodriguez Bravo, Alajuela (CR); David Alonso Campos Batista, Aurora (CR); Kim Poh Wong, Singapore (SG)

(21) Appl. No.: 18/393,774

(22) Filed: Dec. 22, 2023

(51) Int. Cl. H04L 9/40

(52) U.S. Cl. CPC H04L 63/1483; H04L 63/1416

(57) ABSTRACT

Computer-implemented methods for an impersonation attack detection and prevention system. Aspects include receiving a communication from a user of a communication environment. Aspects further include generating a similarity score using metadata of the communication from the user and a digital persona associated with the user in the communication environment. Aspects also include determining that the communication is a potential impersonation attack threat by determining that the similarity score is below a threshold value. Aspects include performing a security action to protect the communication environment from the potential impersonation attack threat.

### BACKGROUND

The present invention generally relates to computer systems, and more specifically, to computer-implemented methods, computer systems, and computer program products configured and arranged to detect and prevent impersonation attacks in a communication environment.

Phishing is a type of social engineering attack that manipulates and deceives users into sharing sensitive information, downloading malware, or otherwise exposing them to cybercrimes. An impersonation attack is a type of spear phishing attack using psychological manipulation, pressure, and/or deception to induce targeted users to perform actions that can expose them to identity theft, credit card fraud, and other financial losses. For example, a malicious actor pretends to be a person or an organization that the user trusts and sends a communication (e.g., email, text message, phone call, or the like), containing a message with a sense of urgency that causes the user to act rashly and share confidential information with the malicious actor, which may lead to huge financial losses for the user or their company.

### SUMMARY

Embodiments of the present invention are directed to computer-implemented methods for an impersonation detection and prevention system in a communication environment. A non-limiting computer-implemented method includes receiving a communication from a user of a communication environment. The method also includes generating a similarity score using metadata of the communication from the user and a digital persona associated with the user in the communication environment. The method further includes determining that the communication is a potential impersonation attack threat by determining that the similarity score is below a threshold value. The method also includes performing a security action to protect the communication environment from the potential impersonation attack threat.

In one embodiment of the present invention, the method includes receiving captured data associated with the user, wherein the captured data includes navigation metadata, navigation habit data, and usage habit data associated with the user. The method further includes generating a fixed value and confidence score for an attribute of the digital persona by applying a K-means clustering algorithm to the captured data. The method includes updating the attribute of the digital persona using the fixed value and the confidence score.

In one embodiment of the present invention, the method includes identifying matches by comparing the metadata of the communication to attributes of the digital persona and determining that a confidence score of an identified attribute is above a minimum threshold. The method further includes calculating the similarity score by using a number of matches identified between the metadata of the communication and the attributes of the digital persona.

In one embodiment of the present invention, the security action includes transmitting the communication to a tool to scan the contents of the communication.

In one embodiment of the present invention, the security action includes transmitting the communication to a quarantine tool for further review.

In one embodiment of the present invention, the security action includes transmitting the communication to an identified recipient by the communication, wherein the communication is displayed with a warning and a request for further action by the identified recipient.

In one embodiment of the present invention, the method includes, in response to performing the security action, updating the digital persona using a q-learning algorithm.

According to another non-limiting embodiment of the invention, a system having a memory having computer readable instructions and one or more processors for executing the computer readable instructions, the computer readable instructions controlling the one or more processors to perform operations. The operations include receiving a communication from a user of a communication environment. The operations also include generating a similarity score using metadata of the communication from the user and a digital persona associated with the user in the communication environment. The operations further include determining that the communication is a potential impersonation attack threat by determining that the similarity score is below a threshold value. The operations also include performing a security action to protect the communication environment from the potential impersonation attack threat.

According to another non-limiting embodiment of the invention, a computer program product is provided. The computer program product includes a computer-readable storage medium having program instructions embodied therewith, the program instructions executable by a processor to cause the processor to perform operations. The operations include receiving a communication from a user of a communication environment. The operations also include generating a similarity score using metadata of the communication from the user and a digital persona associated with the user in the communication environment. The operations further include determining that the communication is a potential impersonation attack threat by determining that the similarity score is below a threshold value. The operations also include performing a security action to protect the communication environment from the potential impersonation attack threat.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of an example computer system for use in conjunction with one or more embodiments of the present invention;

FIG. 2 depicts a block diagram of an example system for detecting and preventing impersonation attacks in a communication environment in accordance with one or more embodiments of the present invention;

FIG. 3 is a data flow diagram of harvesting data from a user to update a digital persona of a user of a communication environment in accordance with one or more embodiments of the present invention;

FIG. 4 is a flowchart of a computer-implemented method for updating a digital persona of a user of a communication environment in accordance with one or more embodiments of the present invention;

FIG. 5 is a flowchart of a computer-implemented method for detecting and preventing impersonation attacks in a communication environment using digital personas in accordance with one or more embodiments of the present invention;

FIG. 6 depicts a cloud computing environment in accordance with one or more embodiments of the present invention; and

FIG. 7 depicts abstraction model layers in accordance with one or more embodiments of the present invention.

### DETAILED DESCRIPTION

Disclosed herein are methods, systems, and computer program products for detection and preventing impersonation attacks in a communication environment. Impersonation attacks are a type of phishing attack that involves fraudulent communications, such as emails, text messages, phone calls, or the like, that are used to deceive their targets into sharing sensitive (e.g., credentials, personal data, etc.) or downloading malware. Impersonation attacks masquerade as a person or organization known to the targets and use pressure tactics and manipulation to drive the victim to act rashly to divulge sensitive information. Phishing scams, including impersonation attacks, can lead to identity theft, financial fraud, ransomware attacks, data breaches, and other similar cybercrimes that ultimately lead to huge financial losses for individuals and companies.

The systems and methods described herein create a layer of defense to detect and prevent impersonation attacks at a corporate or business level by analyzing incoming communications to the digital personas of known users of the system. Examples of the types of impersonation attacks that could be detected and prevented by the systems and methods described herein include, but are not limited to, emails scams, email spams, whaling attacks, false logins, brute force attacks, stolen credentials, and/or abuse of credentials.

A digital persona is a digital representation of a user reflecting their interaction habits within the communication environment. For example, the digital persona includes data indicative a user's navigation, browsing, and usage habits in the communication environment. The digital personas are compared to the communications of the communication environment to determine if they are an impersonation attack threat.

In some embodiments, the system generates a digital persona for all known users of a communication environment, such as a corporate or business network. The system generates a digital persona that reflects the browsing, navigation, and usage habits of a user using their respective user devices while interacting within the communication environment. In some embodiments, the system harvests data generated from the user interactions with the communication environment generated by the user and analyzes the data. In some embodiments, the system executes machine learning techniques that utilize clustering algorithms, such as a K-means clustering algorithm, process the harvested data to generate values reflective of the habits of the user to store in the digital persona associated with the user.

In some embodiments, the system monitors communications of the communication environment, such as emails transmitted through the communication environment. The system can intercept or receive a communication and analyze the communication as a potential impersonation attack threat. In some embodiments, an identity of the sender of the communication is determined. The identify of the sender is used to identify a digital persona for the user. In some embodiments, a digital persona associated with the identified user is retrieved. Values of the attributes stored in the digital persona are compared to the metadata of the communication to identify potential impersonation attack threats. Once a potential impersonation attack threat is identified, one or more security actions are performed to protect the communication environment. Examples of security actions include flagging the communication, quarantining the communication, blacklisting the communication, and the like.

Although the systems and methods described herein are characterized in the context of emails transmitted through a communication environment, the inventive steps can be applied to many different scenarios where data is communicated between users. For example, the systems and methods described herein can be applied to SMS messages, cloud-based communication platforms, voice messaging, or any other type of communication between users. Additionally, the inventive steps can be applied to different systems to enhance the security of other applications and systems, such as platform as a service (PaaS) systems, software as a service (SaaS) systems, intrusion detection systems (IDS), intrusion protection systems (IPS), collaborative systems, and the like.

Various aspects of the present disclosure are described by narrative text, flowcharts, block diagrams of computer systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

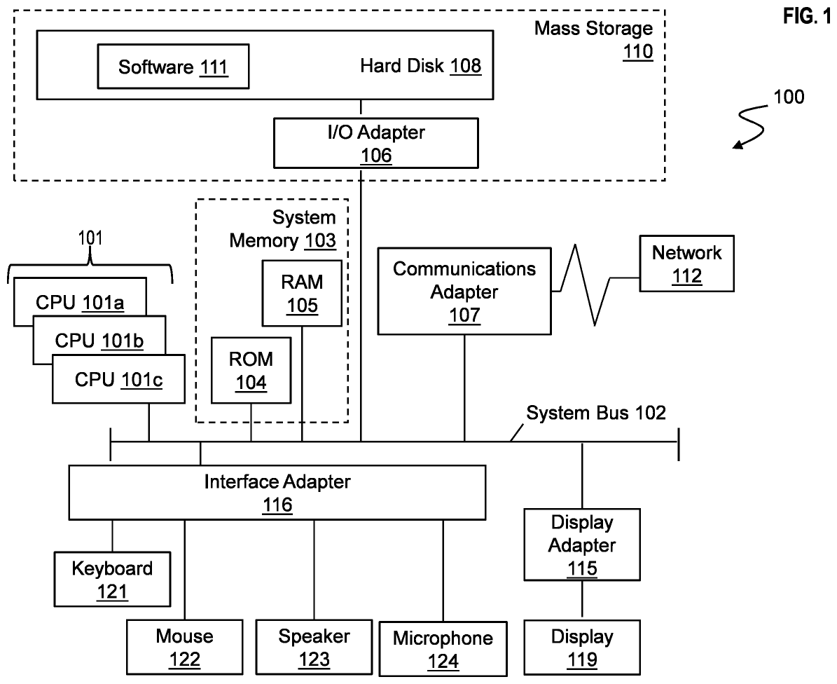

Turning now to FIG. 1, a computer system 100 is generally shown in accordance with one or more embodiments of the invention. The computer system 100 can be an electronic, computer framework comprising and/or employing any number and combination of computing devices and networks utilizing various communication technologies, as described herein. The computer system 100 can be easily scalable, extensible, and modular, with the ability to change to different services or reconfigure some features independently of others. The computer system 100 may be, for example, a server, desktop computer, laptop computer, tablet computer, or smartphone. In some examples, computer system 100 may be a cloud computing node. Computer system 100 may be described in the general context of computer system executable instructions, such as program modules, being executed by a computer system. Generally, program modules may include routines, programs, objects, components, logic, data structures, and so on that perform particular tasks or implement particular abstract data types. Computer system 100 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, the computer system 100 has one or more central processing units (CPU(s)) 101a, 101b, 101c, etc., (collectively or generically referred to as processor(s) 101). The processors 101 can be a single-core processor, multi-core processor, computing cluster, or any number of other configurations. The processors 101, also referred to as processing circuits, are coupled via a system bus 102 to a system memory 103 and various other components. The system memory 103 can include a read only memory (ROM) 104 and a random-access memory (RAM) 105. The ROM 104 is coupled to the system bus 102 and may include a basic input/output system (BIOS) or its successors like Unified Extensible Firmware Interface (UEFI), which controls certain basic functions of the computer system 100. The RAM is read-write memory coupled to the system bus 102 for use by the processors 101. The system memory 103 provides temporary memory space for operations of said instructions during operation. The system memory 103 can include random access memory (RAM), read only memory, flash memory, or any other suitable memory systems.

The computer system 100 comprises an input/output (I/O) adapter 106 and a communications adapter 107 coupled to the system bus 102. The I/O adapter 106 may be a small computer system interface (SCSI) adapter that communicates with a hard disk 108 and/or any other similar component. The I/O adapter 106 and the hard disk 108 are collectively referred to herein as a mass storage 110.

Software 111 for execution on the computer system 100 may be stored in the mass storage 110. The mass storage 110 is an example of a tangible storage medium readable by the processors 101, where the software 111 is stored as instructions for execution by the processors 101 to cause the computer system 100 to operate, such as is described herein below with respect to the various Figures. Examples of computer program product and the execution of such instruction is discussed herein in more detail. The communications adapter 107 interconnects the system bus 102 with a network 112, which may be an outside network, enabling the computer system 100 to communicate with other such systems. In one embodiment, a portion of the system memory 103 and the mass storage 110 collectively store an operating system, which may be any appropriate operating system to coordinate the functions of the various components shown in FIG. 1.

Additional input/output devices are shown as connected to the system bus 102 via a display adapter 115 and an interface adapter 116. In one embodiment, the adapters 106, 107, 115, and 116 may be connected to one or more I/O buses that are connected to the system bus 102 via an intermediate bus bridge (not shown). A display 119 (e.g., a screen or a display monitor) is connected to the system bus 102 by the display adapter 115, which may include a graphics controller to improve the performance of graphics intensive applications and a video controller. A keyboard 121, a mouse 122, a speaker 123, a microphone 124, etc., can be interconnected to the system bus 102 via the interface adapter 116, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI) and the Peripheral Component Interconnect Express (PCIe). Thus, as configured in FIG. 1, the computer system 100 includes processing capability in the form of the processors 101, storage capability including the system memory 103 and the mass storage 110, input means such as the keyboard 121, the mouse 122, and the microphone 124, and output capability including the speaker 123 and the display 119.

In some embodiments, the communications adapter 107 can transmit data using any suitable interface or protocol, such as the internet small computer system interface, among others. The network 112 may be a cellular network, a radio network, a wide area network (WAN), a local area network (LAN), or the Internet, among others. An external computing device may connect to the computer system 100 through the network 112. In some examples, an external computing device may be an external webserver or a cloud computing node.

It is to be understood that the block diagram of FIG. 1 is not intended to indicate that the computer system 100 is to include all of the components shown in FIG. 1. Rather, the computer system 100 can include any appropriate fewer or additional components not illustrated in FIG. 1 (e.g., additional memory components, embedded controllers, modules, additional network interfaces, etc.). Further, the embodiments described herein with respect to computer system 100 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

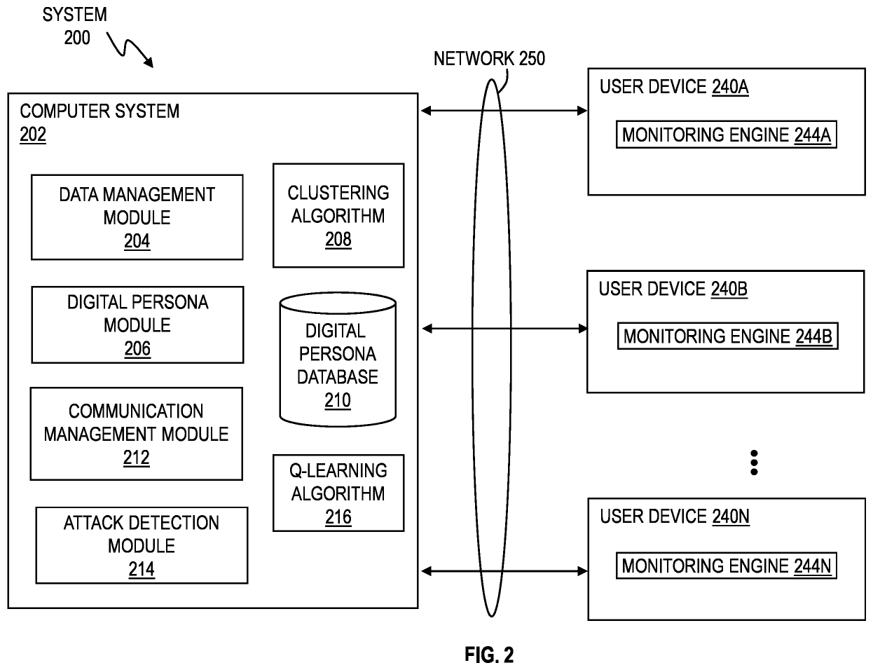

FIG. 2 depicts a block diagram of an example system 200 configured for detecting and prevention of impersonation attacks in a communication environment according to one or more embodiments. The system 200 includes a computer system 202 configured to communicate over a network 250 with many different user devices, such as user device 240A, user device 240B, through user device 240N. The user devices 240A, 240B, through 240N can generally be referred to as user device 240 and are utilized to access the communication environment and are utilized for communication between one another, such as for emails, phone calls, video calls, messaging including short message service (SMS) and multimedia messaging service (MMS), etc. The user device 240 can be a personal computer or laptop. The user device 240 can be a mobile device such as a cellular phone or tablet, or a smart device. A smart device is an electronic device, generally connected to other devices or networks via different wireless protocols that can operate to some extent interactively. Several notable types of smart devices are smartphones, smart speakers, tablets, smartwatches, smart bands, smart glasses, and many others.

The network 250 can be a wired and/or wireless communication network, and the communication network includes a telecommunications network, the public switched telephone network (PTSN), voice over IP (VOIP) network, etc. The communication network includes cellular networks, satellite networks, etc.

The user devices 240 can include various software and hardware components including software applications (apps) for communicating with one another over the network 250 as understood by one of ordinary skill in the art. The computer system 202, user device(s) 240, data management module 204, digital persona module 206 communication management module 212, attack detection module 214, clustering algorithm 208, digital persona database 210, and q-learning algorithm 216, etc., can include functionality and features of the computer system 100 in FIG. 1 including various hardware components and various software applications such as software 111 which can be executed as instructions on one or more processors 101 in order to perform actions according to one or more embodiments of the invention. The data management module 204, digital persona module 206, communication management module 212, attack detection module 214, clustering algorithm 208, digital persona database 210, and q-learning algorithm 216 can include, be integrated with, and/or call other pieces of software, algorithms, application programming interfaces (APIs), etc., to operate as discussed herein.

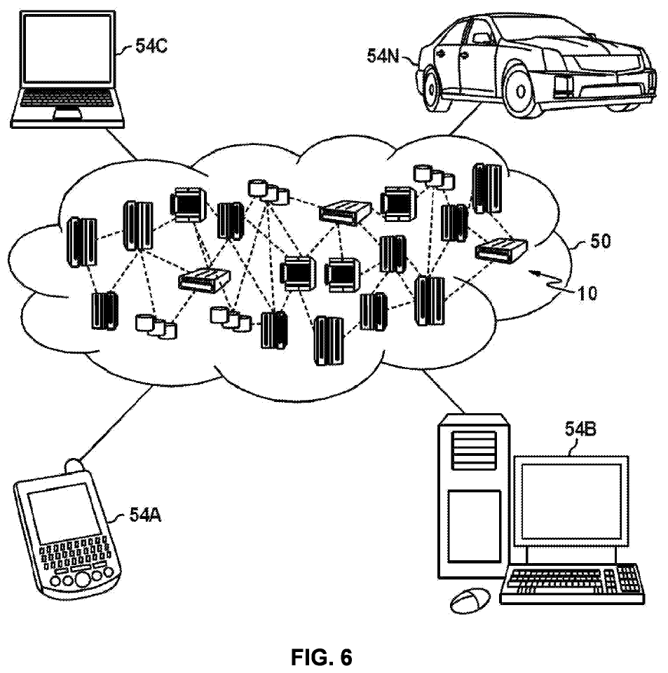

The computer system 202 may be representative of numerous computer systems and/or distributed computer systems configured to provide security services to a user of the user device 240. The computer system 202 can be part of a cloud computing environment such as a cloud computing environment 50 depicted in FIG. 6, as discussed further herein.

In some embodiments, a user device 240 includes a monitoring engine, such as monitoring engine 244A, 244B through 244N, generally referred to as monitoring engine 244. The monitoring engine 244 harvests data generated by the user as they interact with the communication environment using the user device 240. Examples of such data can include navigation metadata, navigation habits, and usage habits of the user. The monitoring engine 244 captures metadata associated with the user and transmits the data over the network 250 to the computer system 202 for processing.

In some embodiments, the computer system 202 can include one or more components to detect and prevent impersonation attacks in a communication environments. For example, the computer system 202 can include data management module 204, digital persona module 206, communication management module 212, attack detection module 214, clustering algorithm 208, digital persona database 210, and/or q-learning algorithm 216.

In some embodiments, the data management module 204 of the computer system 202 receives the data captured and transmitted by a monitoring engine, such as monitoring engine 244A, of a user device, such as user device 240A. The data management module 204 processes the data received from the user device 240A using, for example, a clustering algorithm, such as clustering algorithm 208. In some examples, the clustering algorithm 208 is a K-means clustering algorithm. The processed data is used by the digital persona module 206 to update a digital persona associated with the user of user device 240A. The digital persona may be retrieved from a digital persona database 210 and updated using the processed data from the data management module 204.

To detect possible impersonation attacks in the communication environment, the computer system 202 monitors communications for the communication environment. For example, the communication management module 212 monitors communications, such as emails, and intercepts or receives a communication. The communication indicates that the sender is a user associated with user device 240A. The communication management module 212 transmits the communication to the attack detection module 214 for further analysis.

In some embodiments, the attack detection module 214 retrieves the digital persona associated with the identified sender of the communication, namely the user of user device 240A. The attack detection module 214 compares the metadata of the communication with the digital persona of the identified user. In some embodiments, the attack detection module 214 generates a similarity score using the metadata of the communication and the digital persona. If the similarity score is below a threshold value, the attack detection module 214 performs a security action to protect the communication environment from the possible impersonation attack. If the similarity score is above the threshold value, the communication is delivered to the intended recipient of the communication.

In some embodiments, in response to a security action being performed, the attack detection module 214 can execute or initiate an update to the digital persona of the user using a q-learning algorithm 216 to update or enhance a score of the digital persona to indicate that the identity of the user was used in an impersonation attack.

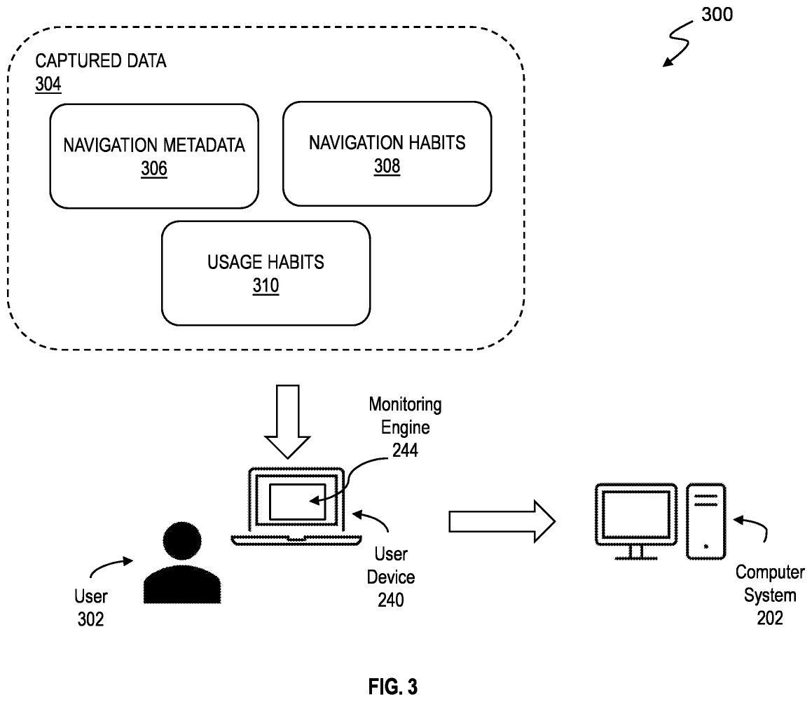

FIG. 3 is a data flow diagram 300 depicting harvesting data from a user device 240 of a user 302 to update a digital persona associated with the user of a communication environment. In some embodiments, a user 302 logs into a user device 240 and accesses a communication environment. As the user 302 interacts with and utilizes the communication environment, the monitoring engine 244 of the user device 240 captures data generated by the user interactions of the user 302. The captured data 304 includes, but is not limited to, navigation data 306, navigation habits 308, and usage habits 310 associated with the user 302. Examples of navigation data 306 include, but are not limited to, an IP address of the current user session of the user 302, browser name, browser version, operating system information (e.g., version, serial number, etc.), installed add-ons, installed plugins, type of user device 240 used (e.g., personal computer, laptop, mobile device, etc.), location of the user device 240 (e.g., GPS location is gathered by most client applications), and the like.

Examples of navigation habits 308 of a user 302 can include, but are not limited to, hours of navigation (e.g., the time of the navigation initiated by the user 302), duration of their session or their connection time, correlation of navigation habits with a browser, and the like. For example, a user 302 may use browser A for personal use and use browser B for work-related tasks. Examples of usage habits 310 of a user 302 can include the method through which the user 302 connects to their email (e.g., mobile application, desktop application, webmail and browser, etc.), the amount of time spent of communications, such as emails, messages, or the like, and connection times.

The different types of data associated with the user 302 are captured by the monitoring engine 244. The monitoring engine 244 can execute, for example, monitoring engine 244 can execute in the background of the computing session of the user device 244. The monitoring engine 244 harvests the data generated by the user 302 during their computing session and transmits the captured data 304 to the computer system 202 for further processing, as described herein.

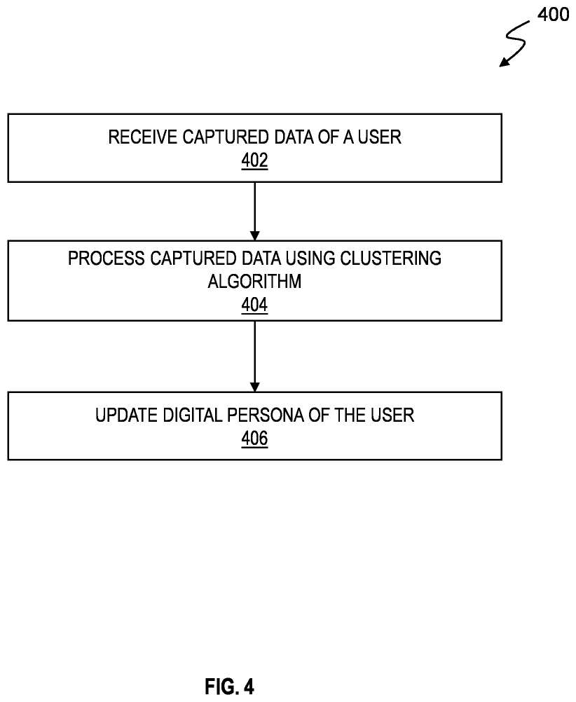

FIG. 4 is a flowchart of a computer-implemented method 400 for updating a digital persona of a user of a communication environment. At block 402 of the computer-implemented method 400, the data management module 204 of the computer system 202 is configured to receive and process captured data 304 of the user devices 240 in an example communication environment (e.g., a corporate environment). The data management module 204 can include, employ, and/or call an engine that is configured to receive the captured data 304 which can include metadata associated with tasks performed by the user 302 on their user device 240. As described in FIG. 3, while the user 302 is performing tasks on their user device 240, a monitoring engine 244 captures metadata generated by the user 302 on their user device 240. The captured data 304 includes navigation metadata 306, navigation habits 308, and usage habits 310 for the user 302. The monitoring engine 244 transmits the captured data 304 to the data management module 204 of the computer system 202. In some embodiments, the monitoring engine 244 transmits the captured data 304 as it is harvested by the monitoring engine 244. In some embodiments, the monitoring engine 244 transmits the captured data 304 at periodic intervals (e.g., every 2 minutes, every 10 minutes). In some embodiments, the monitoring engine 244 transmits the captured data 304 upon completion of the session by the user 304 (e.g., termination of the session, detection of no-input for an identified time interval (15 minutes), or the like).

Next at block 404, the method 400 further includes processing the captured data 304 using a clustering algorithm. In some embodiments, the data management module 204 includes, employs, and/or calls a data processing engine that is configured to process the captured data 304 received from the monitoring engine 244 of a user device 240. The data management module 204 directs the processing of the captured data 304 using a clustering algorithm 208, such as a K-means clustering algorithm. In some embodiments, the data management module 204 directs the processing of the captured data 304 upon receipt of the captured data 304. In some embodiments, the data management module 204 directs the processing of the captured data 304 once the amount of captured data 304 collected for the user reaches a minimum threshold (e.g., period of time, amount of data collected, etc.). Upon exceeding the minimum threshold of received captured data 304, the data management module 204 initiates processing the captured data 304 using the clustering algorithm 208. In some embodiments, the data management module 204 initiates machine learning that employs the clustering algorithm 208 to process the captured data 304.

The clustering algorithm 208 determines clustering patterns in the captured data 304. The clustering algorithm 208 generates a fixed value and confidence score for an attribute of the captured data 304 based on the clustering patterns identified by the clustering algorithm 208. For example, clustering algorithm 208 determines that a user 302 connected to the communication environment from 8:00 AM to 3:00 PM from the user device 240 that is a laptop and connected to their email using a desktop application 90% of the time during weekdays over a period of time of the captured data 304. The data management module 204 generates a fixed value of “8:00 AM to 3:00 PM” for the attribute “Hours of Navigation” for navigation habits 308 with a confidence score of 90. Similarly, a fixed value of “laptop” for the attribute “Device Type” for navigation metadata 306 with a confidence score of 90. Furthering the example, the clustering algorithm 208 determines that the same user 302 connected to the communication environment at 10:00 AM on Saturday mornings from a user device 240 that is a cellular phone and connected to their email using webmail through a browser 50% of the time over the same period of time of the captured data 304. The data management module 204 generates a fixed value of “10:00 AM” for the attribute “Hours of Navigation” for navigation habits 308 with a confidence score of 50.

Next at block 406, the method 400 further includes updating the digital persona of the user 302. In some embodiments, the data management module 204 transmits the generated values to the digital persona module 206. The digital persona module 206 identifies the user 302 and retrieves the digital personal associated with the user 302 from, for example, a digital persona database 210. If the digital persona module 206 determines a digital persona associated with the user 302 does not exist, the digital persona module 206 generates a new digital persona and associates it with the user 302. In some embodiments, a digital persona is generated once a new user profile is created in the communication environment for the user 302.

The digital persona module 206 updates one or more attributes using the fixed values and confidence scores generated using the clustering algorithm 208. In some embodiments, the digital persona module 206 replaces and/or augments values of an attribute using the fixed values and confidence scores generated from the captured data 304. In some embodiments, the digital persona module 206 determines that an attribute does not exist in the digital persona for the user 302 and adds the attribute with the fixed value and confidence score received from the data management module 204. The updated digital persona is stored in the digital persona database 210.

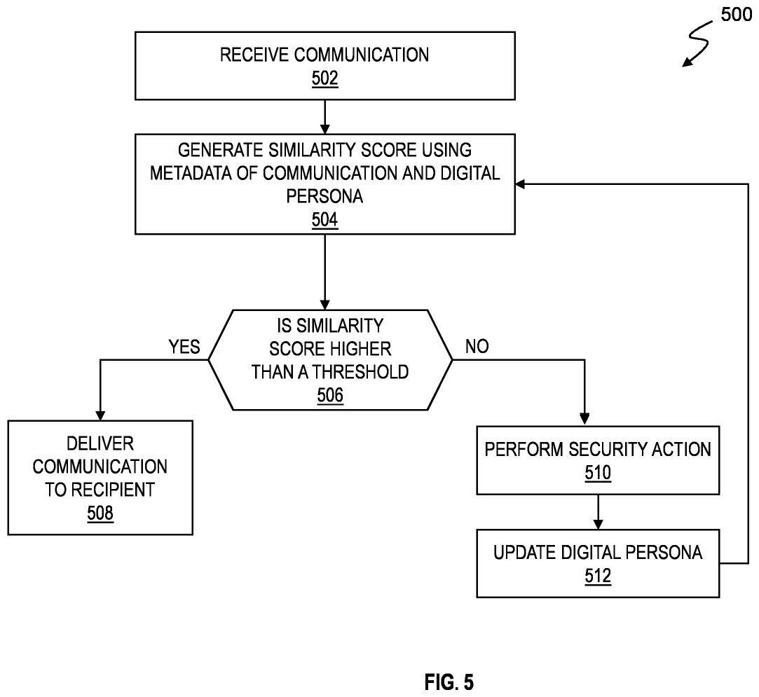

Now referring to FIG. 5, a flowchart of a computer-implemented method 500 for detecting and preventing impersonation attacks in a communication environment is depicted. The method 500 beings at block 502 by receiving a communication. As discussed above, the communication management module 212 of the computer system 202 monitors communications in a communication environment. In some embodiments, the communication management module 212 intercepts or receives a communication. The communication management module 212 determines that the communication is from a user 302 of the communication environment. The communication management module 212 transmits the communication to the attack detection module 214.

Next at block 504, the method includes generating a similarity score using metadata of the communication and a digital persona. In some embodiments, the attack detection module 214 retrieves a digital persona associated with the user identified in the communication from the communication management module 212. The attack detection module 214 retrieves the digital persona from the digital persona database 210. The attack detection module 214 processes the communication to identify one or more attributes that can be used to generate the similarity score. For example, the attack detection module 214 identifies an IP address associated with the communication, a time the communication was transmitted, a type of browser used to transmit the communication, and the type of device used to transmit the communication.

In some embodiments, the attack detection module 214 compares the attributes from the communication with attributes stored in the digital persona. The attack detection module 214 iterates through the attributes of the digital persona and compares the values of the attributes of the digital persona to the values of the attributes from the communication. The values of the attributes of the digital persona are the fixed values and corresponding confidence scores determined by the clustering algorithm 208 using captured data 304 of the user 302, as discussed herein.

In some embodiments, the attack detection module 214 uses a minimum threshold value to identify matches between the attributes of the communication and the attributes stored in the digital persona. The minimum threshold value is a value that is determined by an administrator of the computer system 202. The minimum threshold value, for example, is a value that the confidence score must equal or be higher than in order to be considered a match of the attribute values of the digital persona and the communication.

For example, if the minimum threshold value is 85, the confidence score of the attribute of the digital persona that matches an attribute of the communication much be equal to or higher than 85. If the confidence score of the attribute is an 83, then the attack detection module 214 will not count it as a match, whereas if the confidence score is a 90, the corresponding attribute values in the communication and the digital persona will count as a match for the purpose of generating a similarity score.

The method 500 further includes generating a similarity score using the number of matching attributes between the communication and the digital persona. In some embodiments, the similarity score may be generated using one or more calculations. The calculations may factor other data into the similarity score. In one example, the similarity score is calculated by using the total number of matches found between the communication and the digital persona and the total number of attributes that were compared. To further the example, the total number of matches is divided by the number of comparisons to generate the similarity score.

Next at block 506, the method 500 includes determining if the similarity score is higher than a threshold value. In some embodiments, the threshold value is a value provided by an administrator of the computer system 202. The threshold value is a value that can be adjusted to meet the needs of the users of the computer system 202. For example, if the communication environment of the computer system 202 is associated with high security and confidentiality needs, such as a financial institution, the threshold value is set to a higher value. If the communication environment is associated with a moderate security needs, such as access to a periodical or digital content, the threshold value is set to a lower value.

The method 500 further includes comparing the similarity score with the threshold value. If the attack detection module 214 compares the similarity score with the threshold value and determines that the similarity score is equal to or higher than the threshold value, the method proceeds to block 508 and the communication is delivered to the intended recipient of the communication. In some embodiments, the attack detection module 214 communicates to the communication management module 212 and the communication management module 212 releases the communication and directs delivery of the communication to the intended recipient.

If the attack detection module 214 compares the similarity score with the threshold value and determines that the similarity score is lower than the threshold value, the method proceeds to block 510.

At block 510, the method 500 further includes performing a security action. A security action is one or more actions taken by the computer system 202 to protect the communication environment from an impersonation attack. In one example, the security action includes flagging or otherwise associating the communication with data indicating that it is a potential impersonation attack threat. In some embodiments, the attack detection module 214 identifies any communications flagged as a potential impersonation attack threat to a communication tool to scan the contents of the communication to determine if there is malware or any other type of malicious content. The communication tool processes the flagged communications and adds information about the communication to a blacklist or other type of tracking tool to automatically block or process future communications from the same sender.

In some embodiments, the security action includes transmitting communications flagged as potential impersonation attack threats to a quarantine tool. The quarantine tool is managed by a designated group of administrators of the computer system 202, such as a cyber security team, that reviews the communication and determines the next action to take for the communication, such as blacklisting the communication, adjusting information in the digital persona used to determine the similarity score, or the like.

In some embodiments, the security action includes transmitting the communication flagged as a potential impersonation attack threat to the intended recipient. The communication is displayed to the intended recipient with a warning and a request for further action by the recipient, such as deleting the communication, adding the communication to a blacklist, ignoring the communication, or the like.

Next at block 512, the method 500 further includes updating the digital persona. The attack detection module 214 can communicate to the digital persona module 206 that the user associated with the digital persona is associated with a potential impersonation attack threat. The digital persona module 206 can update the digital persona of the user to indicate that a recent impersonation attack threat used their identity. In some embodiments, the digital persona includes a score indicating likelihood of being used in an impersonation attack in the communication environment. The score of the digital persona can be modified based on different factors such as number of impersonation attacks associated with the user, the frequency of potential impersonation attack threats associated with the user, and the like. In some embodiments, the digital persona module 206 utilizes an algorithm, such as the q-learning algorithm 216, to update the digital persona in response to determining that a potential impersonation attack threat was associated with the user of the digital persona. In some embodiments, the digital persona module 206 initiates or executes the q-learning algorithm 216 in response to the performance of a security action, upon the digital persona used to determine the similarity score, as discussed in blocks 504 and 506.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

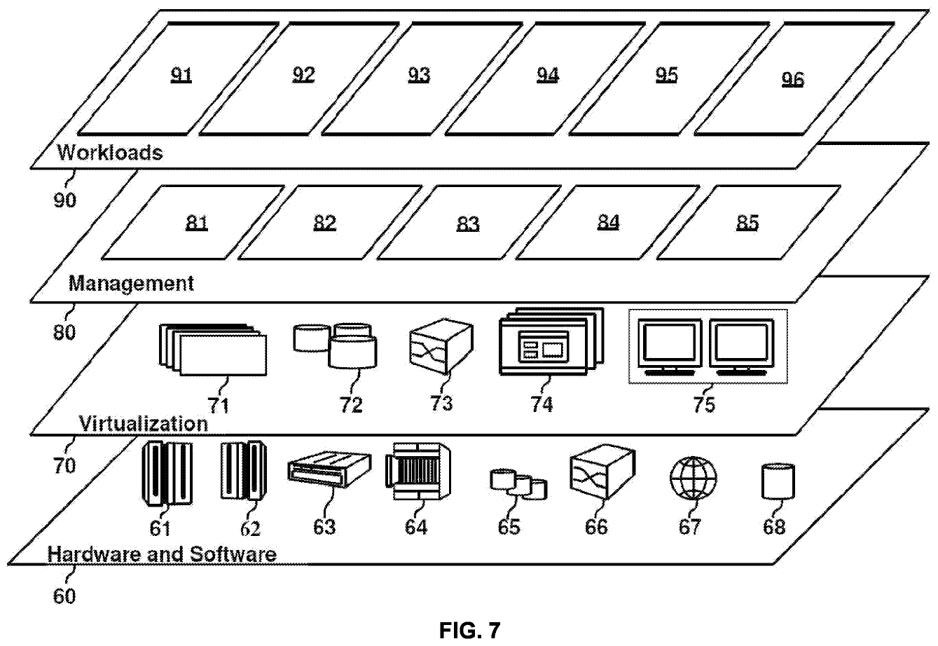

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described herein above, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 7 are intended to be illustrative only and that computing nodes 10 and cloud computing environment 50 can communicate with any type of computerized device over any type of network and/or network addressable connection (e.g., using a web browser).

Referring now to FIG. 7, a set of functional abstraction layers provided by cloud computing environment 50 (depicted in FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and workloads and functions 96.

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

In some embodiments, various functions or acts can take place at a given location and/or in connection with the operation of one or more apparatuses or systems. In some embodiments, a portion of a given function or act can be performed at a first device or location, and the remainder of the function or act can be performed at one or more additional devices or locations.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The present disclosure has been presented for purposes of illustration and description but is not intended to be exhaustive or limited to the form disclosed. Many modifications and variations will be apparent to those of ordinary skill in the art without departing from the scope and spirit of the disclosure. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the actions can be performed in a differing order or actions can be added, deleted, or modified. Also, the term “coupled” describes having a signal path between two elements and does not imply a direct connection between the elements with no intervening elements/connections therebetween. All of these variations are considered a part of the present disclosure.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
receiving a communication from a user of a communication environment;
generating a similarity score using metadata of the communication from the user and a digital persona associated with the user in the communication environment;
determining that the communication is a potential impersonation attack threat by determining that the similarity score is below a threshold value; and
performing a security action to protect the communication environment from the potential impersonation attack threat.

2. The computer-implemented method of claim 1, further comprising:
receiving captured data associated with the user, wherein the captured data comprises navigation metadata, navigation habit data, and usage habit data associated with the user;
generating a fixed value and confidence score for an attribute of the digital persona by applying a K-means clustering algorithm to the captured data; and
updating the attribute of the digital persona using the fixed value and the confidence score.

3. The computer-implemented method of claim 1, wherein generating the similarity score further comprises:
identifying matches by comparing the metadata of the communication to attributes of the digital persona and determining that a confidence score of an identified attribute is above a minimum threshold; and
calculating the similarity score by using a number of matches identified between the metadata of the communication and the attributes of the digital persona.

4. The computer-implemented method of claim 1, wherein the security action comprises transmitting the communication to a tool to scan the contents of the communication.

5. The computer-implemented method of claim 1, wherein the security action comprises transmitting the communication to a quarantine tool for further review.

6. The computer-implemented method of claim 1, wherein the security action comprises transmitting the communication to an identified recipient by the communication, wherein the communication is displayed with a warning and a request for further action by the identified recipient.

7. The computer-implemented method of claim 1, further comprising:
in response to performing the security action, updating the digital persona using a q-learning algorithm.

8. A system comprising:
a memory having computer readable instructions; and
one or more processors for executing the computer readable instructions, the computer readable instructions controlling the one or more processors to perform operations comprising:
receiving a communication from a user of a communication environment;
generating a similarity score using metadata of the communication from the user and a digital persona associated with the user in the communication environment;
determining that the communication is a potential impersonation attack threat by determining that the similarity score is below a threshold value; and
performing a security action to protect the communication environment from the potential impersonation attack threat.

9. The system of claim 8, wherein the operations further comprise:
receiving captured data associated with the user, wherein the captured data comprises navigation metadata, navigation habit data, and usage habit data associated with the user;
generating a fixed value and confidence score for an attribute of the digital persona by applying a K-means clustering algorithm to the captured data; and
updating the attribute of the digital persona using the fixed value and the confidence score.

10. The system of claim 8, wherein the operations to generate the similarity score further comprise:
identifying matches by comparing the metadata of the communication to attributes of the digital persona and determining that a confidence score of an identified attribute is above a minimum threshold; and
calculating the similarity score by using a number of matches identified between the metadata of the communication and the attributes of the digital persona.

11. The system of claim 8, wherein the security action comprises transmitting the communication to a tool to scan the contents of the communication.

12. The system of claim 8, wherein the security action comprises transmitting the communication to a quarantine tool for further review.

13. The system of claim 8, wherein the security action comprises transmitting the communication to an identified recipient by the communication, wherein the communication is displayed with a warning and a request for further action by the identified recipient.

14. The system of claim 8, wherein the operations further comprise:
in response to performing the security action, updating the digital persona using a q-learning algorithm.

15. A computer program product comprising a computer readable storage medium having program instructions embodied therewith, the program instructions executable by one or more processors to cause the one or more processors to perform operations comprising:
receiving a communication from a user of a communication environment;
generating a similarity score using metadata of the communication from the user and a digital persona associated with the user in the communication environment;
determining that the communication is a potential impersonation attack threat by determining that the similarity score is below a threshold value; and
performing a security action to protect the communication environment from the potential impersonation attack threat.

16. The computer program product of claim 15, wherein the operations further comprise:
receiving captured data associated with the user, wherein the captured data comprises navigation metadata, navigation habit data, and usage habit data associated with the user;
generating a fixed value and confidence score for an attribute of the digital persona by applying a K-means clustering algorithm to the captured data; and
updating the attribute of the digital persona using the fixed value and the confidence score.

17. The computer program product of claim 15, wherein the operations to generate the similarity score further comprise:
identifying matches by comparing the metadata of the communication to attributes of the digital persona and determining that a confidence score of an identified attribute is above a minimum threshold; and
calculating the similarity score by using a number of matches identified between the metadata of the communication and the attributes of the digital persona.

18. The computer program product of claim 15, wherein the security action comprises transmitting the communication to a tool to scan the contents of the communication.

19. The computer program product of claim 15, wherein the security action comprises transmitting the communication to a quarantine tool for further review.

20. The computer program product of claim 15, wherein the security action comprises transmitting the communication to an identified recipient by the communication, wherein the communication is displayed with a warning and a request for further action by the identified recipient.
